(19) United States
(12) Patent Application Publication
(10) Pub. No.: US 2009/0065671 A1
(43) Pub. Date: Mar. 12, 2009

(54) Adjusting device and fixing device

(76) Inventor: Harald Burgstaller, St. Florian (AT)

Correspondence Address: Horst M Kasper, 13 Forest Drive, Warren, NJ, 07059, US

(21) Appl. No.: 10/585,272

(22) PCT Filed: Dec. 22, 2004
(86) PCT No.: PCT/EP04/14613

§ 371 Date: Jun. 22, 2006

(51) Int. Cl. F16M 11/14; A47B 96/06

(52) U.S. Cl. 248/288.31; 248/288.11

(57) ABSTRACT

The Invention relates to an adjusting and fixing device comprising a base body (1) and one or several fixing bodies (4,5) arranged therein for fixing at least two components at a distance from each other in a stationary manner. A fixing body (4,5) is inserted in a rotatable and pivotable manner into each end area (2,3) of the base body (1) and is maintained in place on the outside. A pressure body (6,7) can be displaceably connected to the base body (1), from the outside inwards, whereon a wedge piece (8) is arranged at a right angle in relation to the direction of displacement of the pressure body (6,7) which fixes the fixing bodies (4,5) to said pressure body (6,7).

The Invention relates to an adjusting and fixing device for several building components to be disposed at defined distances and positions relative to each other according to the features of the preamble of claim 1.

Known devices comprise several individual parts, which are applied separately and successively, such as perhaps at pre-hung front pieces, as for example at so-called passive houses, new constructions or renewals, were initially the anchorages are to be applied in the masonry walls, and wherein thereupon supports are attached at the anchorages, wherein the supports carry the wood construction, wherein measurement tolerances and particular construction shapes can be processed with big difficulties.

In addition, once applied building parts can only be removed or exchanged with expenditures. Furthermore a large expenditure in wood and therewith a heavy construction is required in order to reach the required static stiffness of the scaffold, and a high worker expenditure is connected therewith and the thermal insulation is additionally substantially decreased based on the large component of wood.

It is an object of the present Invention to generate a device by way of which connections between building parts at precisely defined distances and positions relative to each other can be aligned and fixed, wherein the device quickly and simply can be applied and the fixed position of the building parts can be obtained with high stiffness of the device, with the possibly lowest material components and lowest expenditure of support items. In addition, the setting of the device in all spacial directions is to be possible over a wide angle region, the adaptation of the device to different connection shapes is to be set in a simple manner, as well as a disengagement of already fixed connections can again be quickly performed and a reuse of the adjustment device and fixing device is to be possible.

This object is accomplished with the features of the characterizing parts of claim 1 in connection with the initially recited kind according to the preamble of the claim 1. The sub claims refer to particularly advantageous embodiments of the Invention and form together with claim 1 simultaneously a part of the description of the Invention.

The construction of an adjusting and fixing device for the fixation of building parts of an arbitrary kind, in particular however of hanged over facade pre-constructions, out of a base body, wherein attachment bodies rotatably and swivelably are employed in the end region, wherein the attachment bodies are disposed between opposite to each other to be fixed building parts and are attached to these building parts, there results a free setting possibility of the building parts relative to each other. The disengageable fixation in the desired position by employing small pressure forces is possible based on applying a wedge piece inserted into the base body at a right angle to the pressure transferring shiftable pressure bodies, wherein the hinged attachment bodies freeze and resist to high counter forces at a right angle to the small pressure forces based on a high friction of forces between the attachment bodies and the base body.

A particularly frequently applied form of an adjusting and fixing device comprises the application of a wedge piece between two shiftable pressure bodies.

A maximum of hingeability and therewith of adjustability is accomplished, where the attachment body is applied together with a ball part or also with a shell of a sphere part in the base body and wherein an attachment bolt is attached at the attachment body solidly, perhaps as a single piece in case of a forged part, wherein the forged part then can employ an arbitrary attachment part at its free end, wherein the attachment part is applied for the building region, for illumination purposes, for the positioning of sensors or cameras and the like.

The simplest and usually most favorable form is the use of a cylindrical tube as a base body, wherein the ball part or the shell of a sphere part of the attachment body is placed into the base body also because of the fixation function with the small play, wherein the attachment bolt is swivelable over a very wide angle region and in addition is rotatably disposed.

It is also possible to employ a molded tube with a square or a hexagonal cross-section, in case the use is employed for the adaptation of predominantly the ball part or the shell of a sphere part.

The application of a snap ring as a support part in a hollow recess or of an insertion screw part in an inner winding as for the ball part or the shell of the sphere part for easier mounting and particular demounting, wherein the snap ring or retention ring is suitable for support under high friction or where the demounting is dispensed with, then also the narrowing upsetting of the tube can be employed for support. Based on the dismountable construction of the adjusting and fixing device, the exchange of parts can be performed without particular expenditure and an adaptation, with the different attachment bolts and/or different complete attachment bodies can be performed with respect to changing requirements relative to attachment, load, and geometric dimensions.

The possibility of the application of an attachment bolt at the ball part of an attachment body comprises the use of a thread, in particular where smaller production numbers are involved.

Furthermore it is possible to perform the connection with welding, soldering, frictional welding, riveting, or adhesive attachment even though a single piece forged part is preferred.

The attachment part of the attachment bolt is for example furnished as an anchoring screw for attachment in the wall of a masonry wall and the use of an angled piece or a corresponding screw connection is suitable for attachment to a wood construction, wherein the screw connection can comprise a nut and a counter nut or other standard parts are employed such as they are usually employed in connection with support stands for illumination, photography, sound transmission and the like.

The edge of the tube of the base body coordinated to the attachment bolt is furnished with one or also several recesses for screwing in of an adjustment and fixing device for example in the wall, wherein the breadth and depth of the recesses at least correspond to the diameter of the attachment bolt, that is corresponding to the key width of the hexagon profile of the attachment bolt, such that a screw tool is generated by swiveling of the attachment bolt in the recess of the edge.

In order to avoid flipping, the pressure body is the supported with a small play in the tube or in the insert of the tube and the pressure body is concavely adapted to the ball part or to the shell of sphere part and furnished with a ball shaped convex or a cylindrical convex pressure face relative to the pressure generating wedge piece, in order to keep the friction low.

The wedge piece can be formed either as a pressure wedge piece or as a pull wedge piece and is the most favorably positioned about in the middle of the tube of the base body, wherein two pressure bodies are furnished for two attachment bodies, which attachment bodies then have the same length. The wedge piece is furnished with a thread for a screw connection or with an actuating bolt for a hydro mechanical or electromechanical set member for the remote actuation.

The tube of the base body is furnished with a formed inner thread for adjustment of the pressure wedge, wherein the inner thread is applied in a formed on tube socket for improvement of the guiding and for receiving of the counter force or which inner thread is applied in a nut welded on above a bore hole. In case of a pull wedge in contrast, a bore hole is provided in the queue with the milled key face for this seat of the pull nut on the thread of the bolt extension of the pull wedge piece.

The wedge piece is furnished with a guide in a guide bore hole in the tube jacket at the oppositely disposed tube side of the base body of the adjusting and fixing device for improvement of the guiding for the support of the wedge piece.

The hardening of the pressure faces with high surface hardness and the formation of high strength is favorable for the durability of the wedge piece, since thereby a forming at the pressure bodies is accomplished in a limiting case, by way of which the safety against turning of the complete hinge is increased.

For improving the rigid position of a hinge against rotation, it is possible to furnish the pressure body with one or also several back centers at that face which is the directed toward the ball part, wherein the back centers are somewhat staggered out of center relative to the axis of the hinge and wherein the back centers press themselves into the ball base, in order to secure in a better way against rotation. It is also possible to produce the fixation with an inserted ring or with several part rings or with inserted hard metal or with hardened steel balls. The repositioning and the opening of the hinge can be furnished with a pressure spring inserted between the pressure body and the ball part.

It is important for the production of a stable scaffold under use of a plurality of adjusting and fixing devices to position the attachment bodies of successively following or next to each other disposed base bodies to the attachment bolts spatially changing deviatingly in three spacial directions; this is in particular of importance in connection with facade pre-fronts because of their size and their weight.

The dismountable construction of the adjusting and fixing device is favorable for the saving use and for the rebuilding and for changes in the construction, since attachment bodies or pressure bodies can be exchanged and can be alternated with such elements of different construction type.

A very quickly adjustable and fixable adjusting and fixing device is generated with this Invention construction, wherein the adjusting and fixing device can be employed in a wide region and can be reused after deployment.

The construction allows handles of up to 60 degrees and more in all spacial directions and the attachment bodies of which are combined arbitrarily with each other already at one device and can be employed according to a building block system, depending on need in a wide load and distance region. The fixation can be performed rapidly and precisely and offers a tremendous alleviation of work in case of commercial employment.

In case of application for pre-hung elements such as frame wood of facades, then be recited advantages are very substantial in particular also in connection with passive houses with the pre-mounted wood construction with up to 30 cm heat insulation placed in front of a brick wall.

The dowel plugs are applied at the application location staggered on two sides for attaching of the frame wood and the adjusting and fixing devices are screwed in without tool with the attachment bolt in screw connection position, wherein the oppositely disposed attachment bolt carries a screw for screwing in. Thereupon the frame wood is mounted in the predetermined position and distance. The inclined relative to each other staggered arrangement of the devices results always in a triangular or trapezoidal arrangement with high stiffness in all dissections.

The fixation at a frame part is alleviated, in particular when this frame part comprises wood, with the grooving over sufficient length at the free end of the attachment bolt of an attachment body of the adjusting and fixing device, since then the fixation is reinforced by pressing into wood. The fixation with an attachment part, presented in the shape of a loose angled piece, is performed by screwing in each case, also in case of frame parts made of metal easily changeable and stable, wherein perhaps a counter plate is employed at the frame part.

An angle formation of the attachment bolt is advantageous, narrow at the attachment position at the attachment body, with an angle relative to the bolt axis of from about 10 to 45 degrees, wherein the 30 degrees are particularly advantageous, in order to apply frame parts of a pre-wall completely at a masonry wall, simultaneously the resistance moment is the very much enlarged at a small distance of an angle formation caused by the lever action. Furthermore several adjusting and fixing devices can be applied therewith in a substantially simpler way in a triangle combine aligned at an inclined angle in all spacial directions, by way of which an extraordinary stiffness and loadability can be achieved, while the arbitrariness of the arrangement of the adjusting and fixing devices remains present nearly without limitation.

The connection of the attachment bolt furnished with a grooving is here achieved with an attachment part, wherein the attachment part is formed as a loose angled part having an impression for the attachment bolt, wherein the impression is applied at the right angle running relative to the angle formation and equipped on the inside with grooves and furnished with an attachment arrangement for applying preferably at wood.

The loose angled piece is furnished for the leading through of the free end of the attachment bolt at the angle formation, furnished for impressing with the passage opening, wherein an adjustment of the attachment bolt in its longitudinal axis is possible over a wide region, wherein the grooves of the attachment bolt with the groove structure of the impression result in a stable fixation as soon as the angled piece is screwed onto a frame part.

For this purpose the arm with the impression is furnished with bore holes for screw connections; wherein the attachment at frame parts out of wood can be reinforced with the forming in of the attachment bolt of from 1 to 2 mm into the wood.

With this arrangement there's generated a height level adjustable frame angle, wherein the height level adjustable frame angle substantially simplifies the assembly and the mounting.

The Invention has numerous possibilities of application, which are recited in the following in a non-complete way:

In connection with predisposed facades, for the frame wood and similar,

for pre-disposed profiles and shaped tubes;
in scaffolding, as connection and support elements;
in tents, presentation platforms, fair exhibit kiosk construction;
with interior construction, such as the dry construction with hanged ceilings and with rafter doubling,
with passive house facades and groove areas, for the rafter insulation and in wood frame construction;
with shell and boarding construction, where the reuse is particularly advantageous and valuable;
with floor top constructions in the dry construction;
with the cable channel attachment and the cable channel hanging;
with construction plumbing, for the attachment of gutters;
with insulation construction and ventilation construction, for the attachment of the tube systems;
within the connection and hanging of current carrying elements, possibly with nonconducting hinge ball or hinge shell;
with the attachment of railings, and hand rail banisters and balustrade para-pets and the like;
with the distance spacers for the structural steel reinforcement;
with guide rail attachments;
with civil and underground engineering for the support of cunette shells;
with the vehicle support, for construction machines, for construction trucks and the like;
with the steel construction, for weld-on parts; with machine construction, for limit stops and the clamping of materials, possibly for tool tables with T-groove guides;
with glass construction, for the attachment of attachment glass panes;
with a joiners workshop, for the limit stops and quick adjustment support;
with medical technology, for the quick adjustment and quick arresting of medical instruments;
with the defense technology, for tripod supports and the construction of satellite systems;
with the quickly adjustable and quickly arrestable attachment of: lamps, sensors, monitoring cameras, motion monitors, antennas, satellite systems, sun protection, navigation systems, free speaker installations, cellular phone supports, fitness apparatus, radar apparatus for road monitoring, traffic signs, traffic mirrors, advertising displays, waste containers.

An embodiment of the Invention is the described in the following by way of the drawing.

There is shown in:

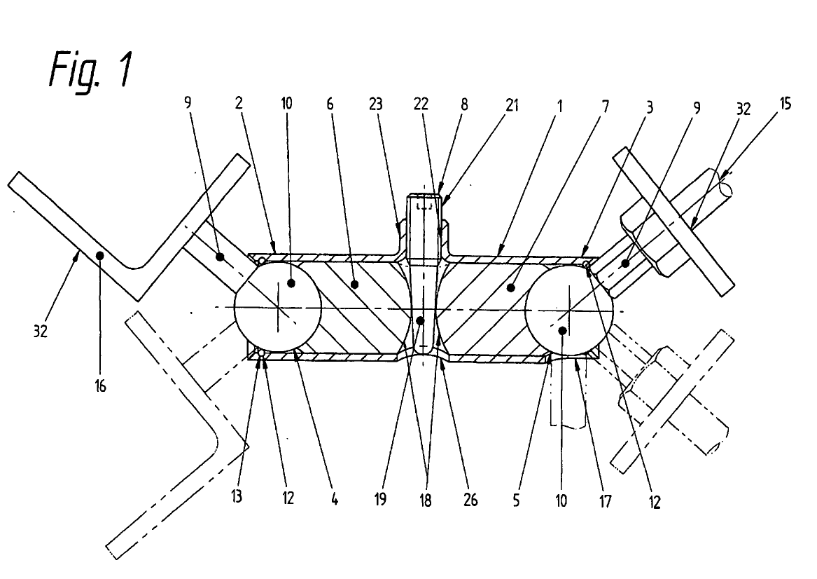

FIG. 1 a section through an adjusting and fixing device with the pressure wedge for fixation and with an anchor screw and an angle piece item,

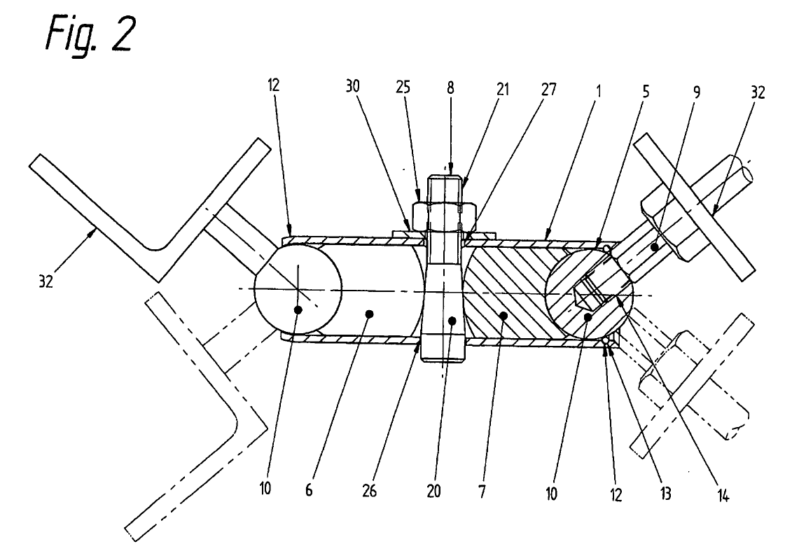

FIG. 2 a section through an adjusting and fixing device with a pull wedge for fixation and with an anchor screw and an angle piece item,

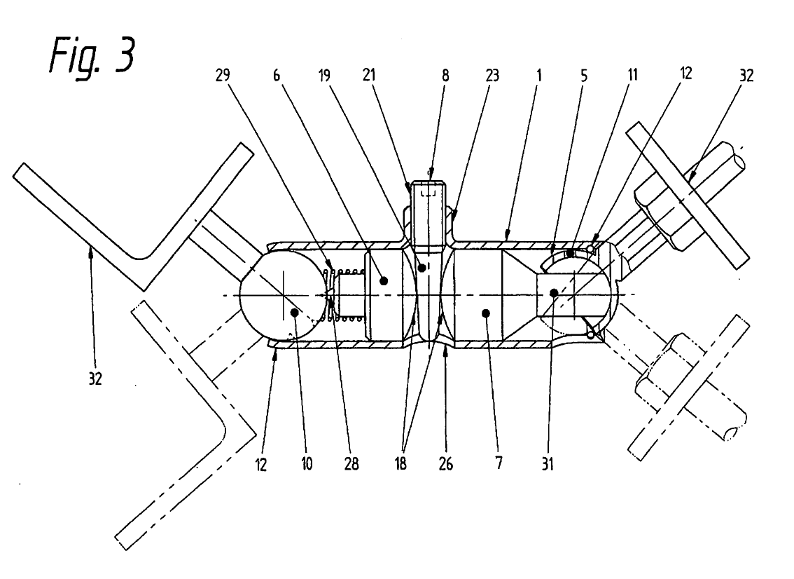

FIG. 3 a section through an adjusting and fixing device with the pressure body with back center for fixation at the ball part of an attachment body and the spring for restoring, as well as a pressure body engaging in a shell part of an attachment body,

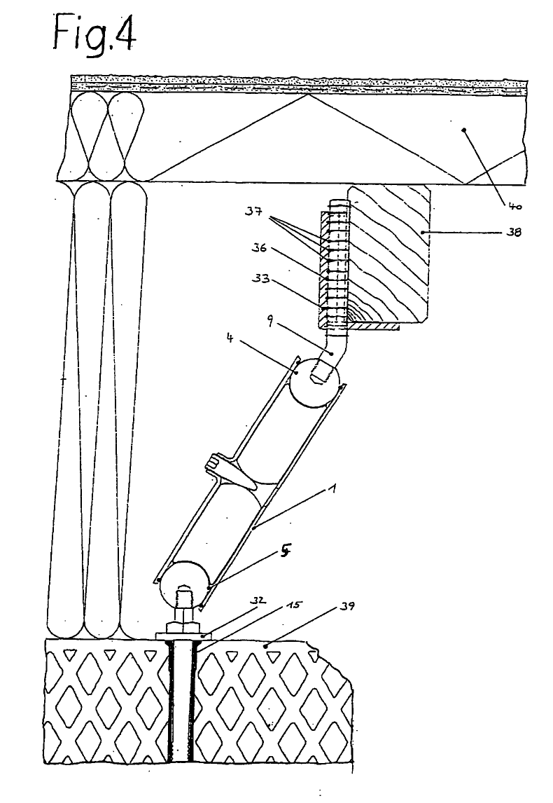

FIG. 4 a section through a wall construction with masonry works, pre-wall with frame construction and insulation, with mounted adjusting and fixing device with angled off attachment bolt,

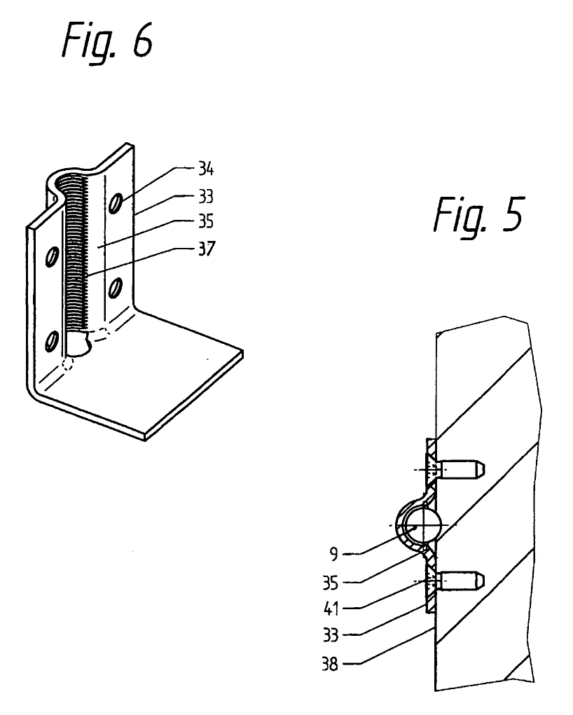

FIG. 5 a partial sectional view of a frame wood according to FIG. 4 with a loose angled piece having a screw connection and with fixed attachment bolt,

FIG. 6 a loose angled piece according to FIGS. 4 and 5 in an inclined view.

The adjusting and fixing device illustrated in FIG. 1 shows a cylindrical tube as a base body 1, wherein a first attachment body 4 with an angle piece 16 at the free end of the attachment bolt 9 is placed in the first end region 2 of the base body 1 and wherein a second attachment body 5 with an anchor screw is attached at the free end of the attachment bolt 9 in the second end region 3 of the base body 1.

The two attachment bodies 4 and 5 comprise in each case a ball part 10, wherein the ball part 10 is inserted with small play in the tube of the base body and wherein the ball part 10 is held toward the outside by a snap retainer ring as a support part 12, wherein the support part 12 is inserted into a recess 13 of the inner wall of the tube.

In each case a first pressure body 6 and a second pressure body 7 with a small play shiftably supported in the tube closes toward the inside and follows to the coordinated ball part 10 with a concave face adapted to the ball face, while the oppositely disposed end face is formed as a ball or cylindrical convex, wherein the oppositely disposed end face theoretically forms a point support or a line support for a wedge piece 8.

The tube is furnished with a formed pipe socket 23, wherein the pipe socket 23 carries a bore hole with an inner thread 22 for the thread 21 of the wedge piece 8 formed as the pressure wedge 19, wherein the wedge piece 8 is here illustrated with a hollow screw connection.

The pressure wedge 19 exerts pressure onto the pressure bodies 6 and 7 disposed on two sides during screwing in, wherein the pressure bodies 6 and 7 in each case push the coordinated ball part 10 against the support part 12 and set the ball part 10 to rigid and vice versa release again the ball part 10.

The guide bore 26 for guide parts is disposed opposite to the wedge piece in the tube wall of the base body 1, wherein the guide parts are not designated in the drawing.

The attachment bodies 4 and 5 are in each case illustrated in oppositely disposed end positions and in addition there is reproduced in each case a middle position and a second end position, wherein the forming of the edges is shown adapted to the attachment bolts.

A still further swiveled position is indicated at the second attachment body 5, wherein the attachment bolt 9 having a hexagonal profile engages into a recess having the key width of the hexagon profile in the second swiveled position and then forms a screw tool for screwing in of the anchor screw 15.

FIG. 2 shows an adjusting and fixing device, where in contradistinction to FIG. 1 there is employed a wedge piece 8 formed as a pull wedge 20, wherein the wedge piece 8 is inserted through the guide bore hole 26 and is guided with the shaft carrying a thread through an oppositely disposed bore hole 27 and wherein the thread carried by the shaft is screwed together with a nut 25, wherein the nut 25 rests on the support disk 13 and wherein the support disk 13 rests on a milled key face 24 of the tube.

The ball part 10 is shown partially in the sectional view at the second attachment body 5, together with an inner thread 14, wherein the attachment bolt 9 with its thread is screwed into the inner thread 14.

A support part 12 for the ball part 10 is produced by narrowing of the tube at the first end region 2 of the tube of the base body 1.

A first attachment body 4 with the first pressure body 6 is shown in FIG. 3 thereby deviating from FIGS. 1 and 2, wherein the pressure body 6 is furnished with a back center 28, wherein the back center 28 is pressed into the ball part 10 during fixation, wherein the counter force of a compression spring 29 enables the release. A shell of a sphere part 11 is furnished at the second attachment body 5, wherein a piston extension 31 of the second pressure body 7 reaches into the interior of the shell of a sphere part 11.

An adjusting and fixing device is illustrated in FIG. 4, wherein the adjusting and fixing device on the one hand is screwed with the anchor screw 15 of the attachment parts 32 of the attachment body 5 into the masonry works 39 of the wall and wherein on the other hand with the attachment bolt 9, wherein the attachment both 9 is angled off at the attachment body 4 by about 30 degrees and wherein the attachment bolt 9 is fixed in the impression 35 of a loose angled piece 33, which angled piece 33 in turn is attached to a frame part 38 made of wood, wherein the frame part 38 made of wood forms part of a pre-wall, wherein the insulation and the outer layer of the pre-wall is recognizable.

The loose angled piece 33 has an impression 35, wherein the impression 35 runs at a right angle to the angle of the angled piece 33 and ends with an opening for the feed through of the attachment bolt 9 in the angle, as can be recognized from FIG. 6.

The impression 35 is furnished on its inside with a scoring 36, wherein the grooves 37 of the attachment body can engage into the scoring 36 during mounting and assembly and the fixation of the attachment bolt 9 according to the height level in axial direction is made possible in different positions depending on the requirements of the assembly and mounting.

The attachment of the attachment bolt 9 in the angled piece 33 is performed with screw connections 41, wherein the screw connections 41 are screwed into the frame part 38 through the bore holes 34 as can be recognized from FIG. 5.

The angling off of the attachment bolt 9 allows the setting of an inclined position corresponding to the geometry of the wall construction and the grooves 37 allow at the same time the adaptation to different distances with the equally remaining high fixation force of the adjusting and fixing device.

### LIST OF REFERENCE CHARACTERS

1 base body
2 first end region of the base body 1
3 second end region of the base body 1
4 first attachment body
5 second attachment body
6 first pressure body
7 second pressure body
8 wedge piece
9 attachment bolt of the attachment bodies 4,5
10 ball part of the attachment bodies 4,5
11 shell of a sphere part of the attachment body 5
12 support part of the attachment bodies 4,5
13 inner recess in the end region 2,3 of the base body 1
14 inner thread in the ball part 10 of the attachment bodies 4,5
15 anchor screw of the attachment bolt 9
16 angle piece of the attachment bolt 9
17 outer recess at the edge of the tube of the base body 1
18 ball shaped or cylindrical convex pressure face of the pressure bodies 6,7
19 pressure wedge of the wedge piece 8
20 pull wedge of the wedge piece 8
21 thread of the pressure wedge 19 or of the pull wedge 20
22 inner thread in the base body 1 for the pressure wedge 19 or the pull wedge 20 of the wedge piece 8
23 formed tube socket at the base body 1 for the pressure wedge 19 or the pull wedge of the wedge piece 8
24 milled key face at the tube of the base body 1 for a wedge piece 8 with pull wedge 20
25 nut for the wedge piece 8
26 guide bore hole in the tube of the base body 1 opposite to the bore hole 27 for the wedge piece 8
27 bore hole for the wedge piece 8
28 dead center of the pressure body 6
29 compression spring between the pressure body 6 with dead center and the ball part 10 of the attachment bodies 4,5
30 bed disk for the nut 25
31 piston of the second pressure body 7 for the shell of a sphere part 11
32 attachment part of the attachment bolt 9
33 loose angle piece
34 bore hole of the angle piece 33 for clamping screw fitting
35 impression for the attachment bolt 9
36 scoring of the attachment bolt 9
37 grooves of the impression 35
38 frame part, in particular frame wood
39 masonry works
40 pre-wall
41 screw connection of the angle piece 33 for the clamping screw connection

1. Adjusting and fixing device comprising a base body and one or several thereupon supported attachment bodies 4 locally fixed fixation of at least two building components at a distance from each other characterized in that an attachment body (4,5) is rotatably and swivelably inserted into each end region (2 and 3) of the base body (1) and wherein the attachment body (4,5) is held toward the outside and wherein in each case a pressure body (6,7) shiftably follows inwardly to the base body (1), wherein the wedge piece (8) shiftable at a right angle relative to the shifting direction of the pressure bodies (6,7) is disposed and fixes with this pressure body (6,7) the attachment body (4,5).

2. Adjusting and fixing device according to claim 1 characterized in that the wedge piece (8) is disposed shiftable to at least two pressure bodies (6,7) shiftable at a right angle to the shift direction of the pressure bodies (6,7), wherein attachment bodies (4, 5) coordinated to these pressure bodies (6,7) are fixed.

3. Adjusting and fixing device according to one of the preceding claims claim 1 characterized in that the attachment bodies (4,5) comprise the ball part (10) or the shell of a sphere part (11) and an attachment bolt (9) fixedly attached to the ball part (10) or to the shell of a sphere part (11) and in particular produced as a forged single piece, and wherein an attachment part (32) is attached that the free end region of the attachment bolt (9).

4. Adjusting and fixing device according to claim 1 characterized in that at least two or several ball parts (10) or shell of a sphere parts (11) with a rigid connection piece, in particular a connection bolt, are disposed at a distance relative to each other and are inserted into at least two or several base bodies (1), wherein in each case ball parts or shell of a sphere parts of attachment bodies (4,5) are inserted at the other ends.

5. Adjusting and fixing device according to claim 1 characterized in that the base body (1) forms a cylindrical tube or a formed tube, into particular with square or hexagonal cross-section, wherein the ends of the tube are adapted to the attachment bolts (9) of the attachment bodies (4,5) and their swivel motions.

6. Adjusting and fixing device according to claim 1 characterized in that the ball part (10) of the attachment body (4,5) is supported with a small play in the cylindrical tube or in an insert with cylindrical cross-section of the formed tube of the base body (1) and wherein the ball part (10) is held toward the outside in the end region (2,3) of the base body (1) by an inserted holding part (12), wherein preferably the holding part (12) is formed by a retainer ring inserted in a recess (13) or in particular by an upsetting of the tube of the base body furnishing a narrowing of the diameter.

7. Adjusting and fixing device according to claim 1 characterized in that the ball part (10) of the attachment body (4,5) is furnished with an inner thread, wherein the attachment bolt (9) with an outer thread is screwed into the inner threat of the ball part (10).

8. Adjusting and fixing device according to claim 1 characterized in that the attachment bolt (9) is welded on, soldered on, friction welded, riveted or adhesively attached at the ball part (10) or at the shell of a sphere part (11) of the attachment body (4,5).

9. Adjusting and fixing device according to claim 1 characterized in that the attachment part (32) of the attachment bolt (9) comprises an anchor screw (15) or an angle piece (16) or a screw connection, preferably with the nut and counter nut or out of other standard parts for the attachment of arbitrary parts.

10. Adjusting and fixing device according to claim 1 characterized in that the edge of the tube of the base body (1) coordinated to an attachment bolt (9) is furnished with at least one recess (17), wherein the width of the recess (17) and the depth of the recess (17) correspond at least to the diameter of the attachment bolt (9), and in particular to the key width of the hexagon profile of the attachment bolt (9).

11. Adjusting and fixing device according to claim 1 characterized in that the pressure bodies (6,7) are shiftably supported with low play in the tube of the base body (1) and exhibit forms adapted to the ball parts (10) or to the shell of a sphere parts (11) and exhibit a ball shaped convex pressure face (18) or a cylindrical convex pressure face directed toward the wedge piece (8), wherein the pressure bodies (6,7) follow inwardly to the ball parts (10) or the shell of a sphere parts (11) of the attachment bodies (4,5).

12. Adjusting and fixing device according to claim 1 characterized in that the wedge piece (8) is formed as a pressure piece or as a pull piece, which engages preferably centered into the tube of the base body (1), wherein a thread (21) or an actuating bolt for a hydro mechanical or electromechanical set member follows toward the outside at the pressure wedge (19) of the wedge piece (8) or at the pull wedge (20) of the wedge piece (8).

13. Adjusting and fixing device according to claim 1 characterized in that the tube of the base body (1) is furnished with a formed in inner thread (22), in particular a formed on tube socket (23) or with a welded on nut or with a bore hole for the wedge piece (8) formed as a pull wedge (20) with thread (21) and with a milled key face (24) for the seat of a nut (25).

14. Adjusting and fixing device according to claim 1 characterized in that the wedge piece (8) is guided at the oppositely disposed side of the tube of the base body (1) in a guide bore (26).

15. Adjusting and fixing device according to claim 1 characterized in that the wedge piece (8) exhibits pressure faces (18) that the pressure wedge (19) or at the pull wedge (20), wherein the pressure faces (18) are furnished with high strength and surface hardness.

16. Adjusting and fixing device according to claim 1 characterized in that the pressure body (6,7) with a face disposed toward the coordinated ball part (10) or shell of a sphere part (11), with at least one back center (28), preferably disposed outside of the longitudinal axis of pressure body (6,7) and ball part (10) or shell of a sphere part (11), or with several distributed dead centers or with a ring or several part rings, preferably inserted or furnished with a compression spring (29) inserted between the pressure body (6,7) and the ball part (10) for the shell of a sphere part (11).

17. Adjusting and fixing device according to claim 1 characterized in that the attachment bodies (4,5) of successively following or next to each other disposed based bodies (1) are aligned and fixed to the attachment bolt (9), in particular at facade front placements, spatially alternating and deviating in three spacial directions, in the kind of webs of grid carriers.

18. Adjusting and fixing device according to claim 1 characterized in that the base bodies (1) are constructed decomposable and can be equipped exchangeably with attachment bodies (4,5) and/or the pressure bodies (6,7) of the same kind or of a different kind.

19. Adjusting and fixing device according to claim 1 characterized in that at least one of the attachment bolts (9) is furnished with a scoring (36) and is preferably close to the attachment location angled off at the attachment body (4 or 5) at an angle to the axis of the attachment bolt of from about 10 to 45 degrees, in particular of 30 degrees.

20. Adjusting and fixing device according to claim 1 characterized in that the attachment part of the attachment bolt (9) furnished with the scoring (36) is formed as a loose angle piece (33), wherein an impression (35) for the attachment bolt (9) is furnished in the loose angle piece (33) running at a right angle to the angling off and equipped on the inside with grooves (37) and is furnished with an attachment arrangement for attaching at frame parts (38), preferably for the attachment at wood.

21. Adjusting and fixing device according to claim 1 characterized in that the loose angle piece (33) exhibits a passage opening for an attachment bolt (9) at the angling off and toward the impression (35) located.

22. Adjusting and fixing device according to claim 1 characterized in that the loose angle piece (33) is furnished with an attachment arrangement for applying at the frame parts (38), preferably with bore holes (34) for school connections (41), for the attachment at frame parts (38) made of wood at the arm with the impression (35).
